(19) United States
(12) Patent Application Publication
(10) Pub. No.: US 2024/0031470 A1
(43) Pub. Date: Jan. 25, 2024

(54) DRIVING RECORDING METHOD

(71) Applicant: Mordechai SHRIKI, Ashdod (IL)

(72) Inventor: Mordechai SHRIKI, Ashdod (IL)

(21) Appl. No.: 18/219,735

(22) Filed: Jul. 10, 2023

Related U.S. Application Data
(60) Provisional application No. 63/390,645, filed on Jul. 20, 2022.

(51) Int. Cl. H04M 1/72454

(52) U.S. Cl. CPC H04M 1/72454; H04M 2250/12

(57) ABSTRACT

A driving recording method, including the steps of: reporting along time to a mobile phone navigation application by a mobile phone, motion of the mobile phone; reporting along time to the mobile phone navigation application by a plurality of other mobile phones, motions of the other mobile phones; comparing the motion of the mobile phone to an average of the motions of the plurality of other mobile phones; and reporting the comparison to a subscriber.

### CROSS-REFERENCE TO RELATED APPLICATIONS

This application claims the benefit of priority from U.S. Provisional Application No. 63/390,645, filed Jul. 20, 2022, the disclosure of which is incorporated herein by reference.

### TECHNICAL FIELD

The invention relates to the field of traffic monitoring and recording.

### BACKGROUND

Car owners do not have efficient tools to monitor who is driving their vehicle. It is difficult today for parents, for example, to monitor the manner and quality of their children's driving when they entrust them with their vehicles.

There is a long felt need to provide a solution to the above-mentioned and other problems of the prior art.

### SUMMARY

In one embodiment of the invention a driving monitoring method is provided, including the steps of reporting motion of a mobile phone (60), reporting by a plurality of other mobile phones, motions of the other mobile phones, and comparing and reporting.

### BRIEF DESCRIPTION OF THE DRAWINGS

Embodiments, features, and aspects of the invention are described herein in conjunction with the following drawings:

FIG. 1 schematically illustrates an exemplary vehicle driver monitoring system, according to an embodiment of the invention.

FIG. 2 schematically illustrates the exemplary vehicle driver monitoring system of FIG. 1.

FIG. 3 is a chart produced by a mobile phone navigation application according to one embodiment of the invention.

FIG. 4 depicts the monitoring service provided in relation to the information of FIG. 1.

FIG. 5 depicts monitoring service provided in relation to information of driving at the same time of the monitored time and of the public.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention.

They are meant to be merely illustrative, and not limiting. Also, the foregoing embodiments of the invention have been described and illustrated in conjunction with systems and methods thereof, which are meant to be merely illustrative, and not limiting.

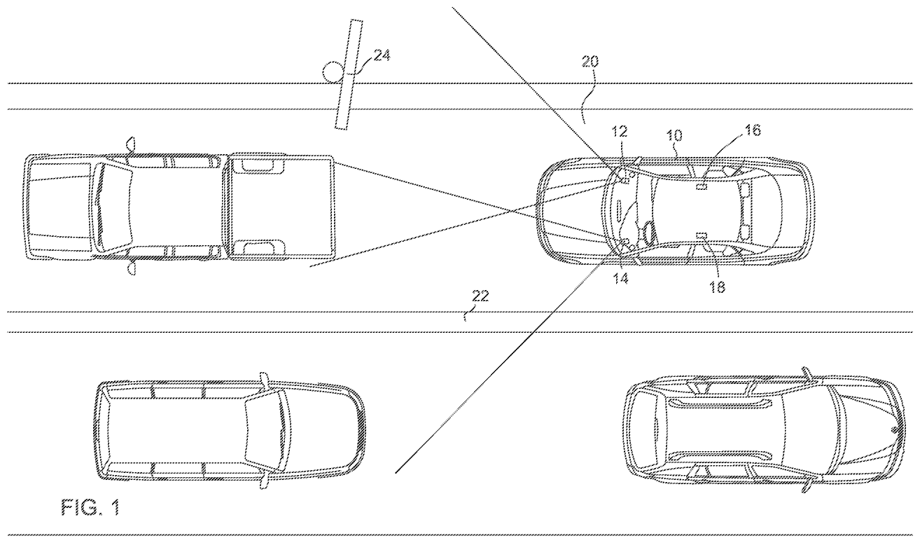

FIG. 1 schematically illustrates an exemplary vehicle driver monitoring system, according to an embodiment of the present invention. Shown in the figure is a vehicle (10) traveling on a road (60) including the vehicle warning system with two cameras (12,54) and a system of inertial detectors (18) connected to a controller (16). The controller (16) is configured to analyze the photographs from the cameras (12,54) and to identify in real time vehicles on the road, signs (24) and markings on the road (62). as well as the controller analyzes the data from the inertial sensors (18) and the speed of the vehicle (10).

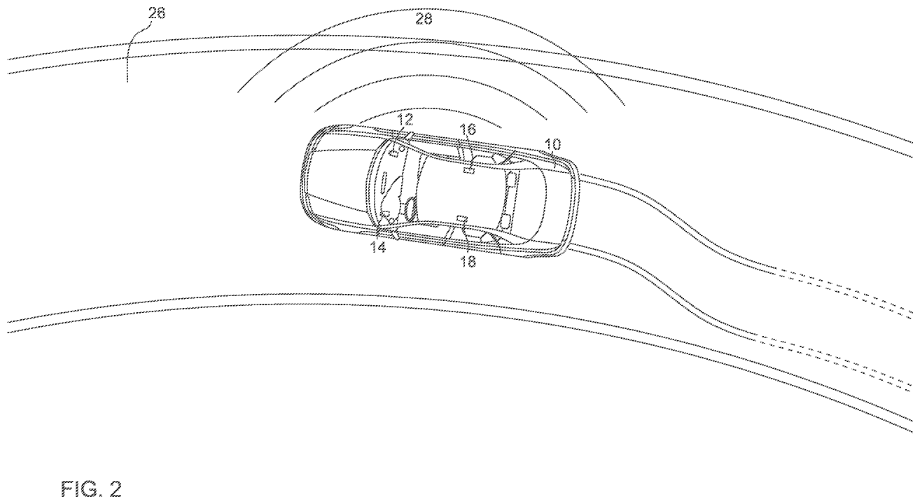

FIG. 2 schematically illustrates the exemplary vehicle driver monitoring system, according to an embodiment of the present invention. Shown in the figure is the vehicle (10) traveling fast on a curved road (66) and acted upon by centrifugal forces (68). The inertial sensors (18) detect these forces and transmit them to the controller (16). The cameras (12,54) analyze the traffic lights, traffic signs, and road markings.

A prior art mobile phone navigation application, such as WAZETM, receives locations along time from various mobile phones, and provides a display including a map including the vehicle's location within the map.

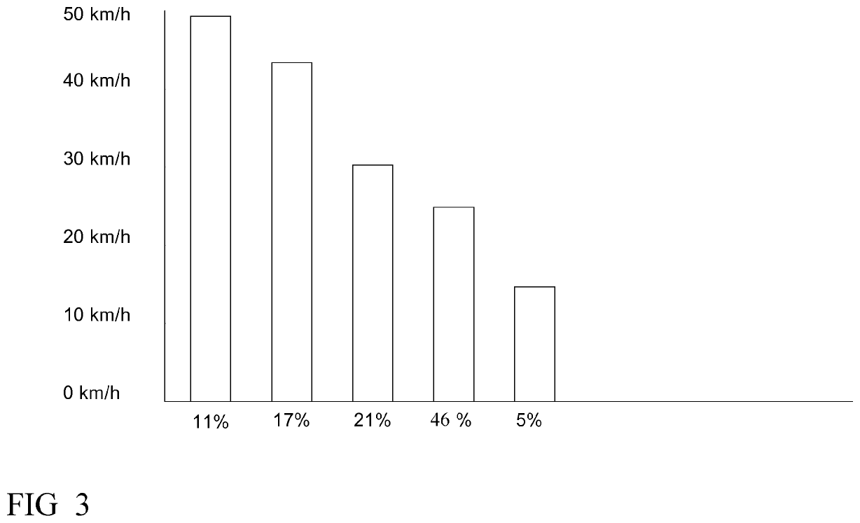

FIG. 3 is a chart produced by a mobile phone navigation application according to one embodiment of the invention.

A mobile phone navigation application may analyze that at a certain street 16A at a certain hour 16B at various dates, 11% percent of the anonymous phones within vehicles advance 50 km per hour, 17% percent of the anonymous phones advance 40 km per hour, etc. the example depicted in FIG. 1.

The mobile phone navigation application may further calculate a weighted average of (50×11+40×11+30×21+60×46+10×5)/100=66 km/hr.

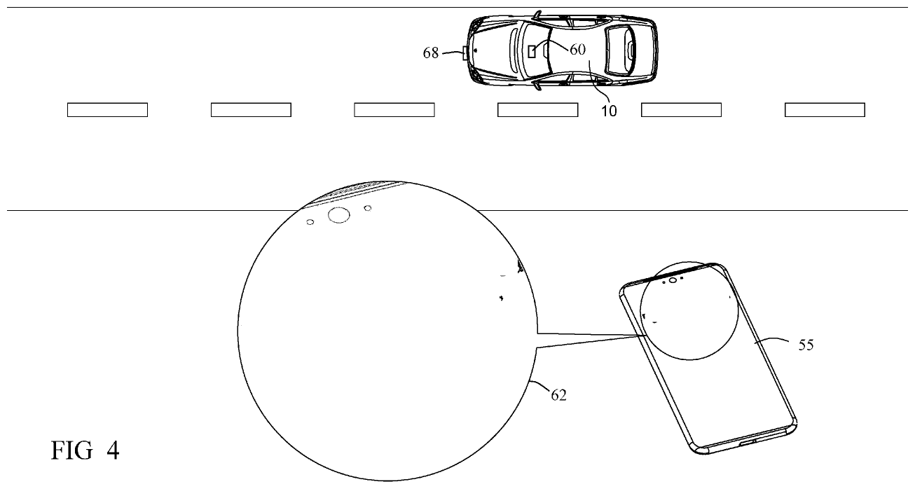

FIG. 4 depicts the monitoring service provided in relation to the information of FIG. 1.

A subscriber 55 may request a service of tracking a certain phone 60. For example a parent having phone 55 may pay for services of the mobile phone 60 of his son, and may pay the mobile phone navigation application for receiving reports 62.

The mobile phone navigation application as receiving locations and motions of the tracked phone 60 along time may obtain that phone 60 at street 16A at hour 16B at a certain date advances 45 km per hour.

The mobile phone navigation application may then compare the speed 45 km/hr of phone 60 to weighted average speed of 66 km/hr, for alerting extreme speed in relation to average of the public being a reliable safety criterion, rather than in relation to the speed of the law, being an arbitrary criterion.

The mobile phone navigation application may provide phone 55, the display including the map and the locations of phone 60 along that time and location, to send it to the subscriber of the service, being the parent, which may include a video of the event by a dashboard camera 68, the period of the recording according to the period of the event.

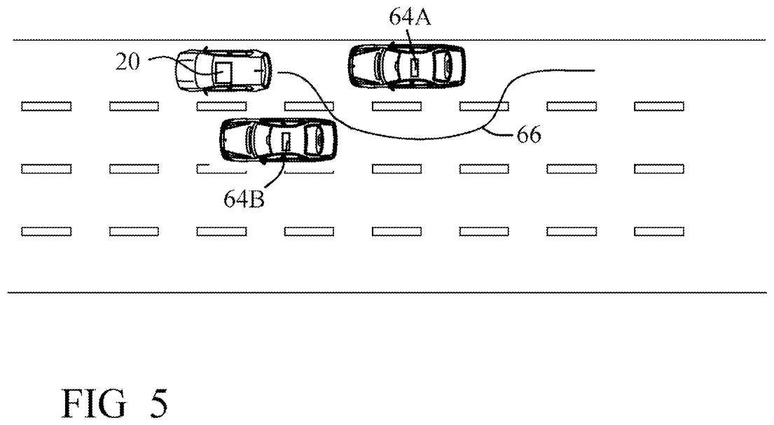

FIG. 5 depicts recording service provided in relation to information of driving at the same time of the monitored time and of the public.

The mobile phone navigation application may compare the driving reported by phone 60 to the driving of the public as reported by phones 64A and 64B at the same time and location reported by their plurality of mobile phones 64A and 64B.

For example, the mobile phone navigation application may notice that the weighted average speed of the public driving around phone 60 at a certain time and location is 80 km/hr whereas the speed of phone 60 at that time and location is 100 km/hr.

The mobile phone navigation application may further analyze undertakes 66 of phone 60 in relation to the public.

The mobile phone navigation application may provide the display including the map and the locations of phone 60 and of phones 64A and 64B of the public surrounding phone 60 along that time and location, to send it to the subscriber of the service.

Thus, in one aspect, the invention is directed to a driving monitoring method, including the steps of:
reporting along time to a mobile phone navigation application by a mobile phone (60), motion of the mobile phone (60);
reporting along time to the mobile phone navigation application by a plurality of other mobile phones (64A,64B), motions of the other mobile phones (64A,64B);
comparing the motion of the mobile phone (60) to an average of the motions of the plurality of other mobile phones (64A,64B); and
reporting (62) the comparison to a subscriber (55).

The reported motion of the mobile phone (60) and the reported motions of the plurality of other mobile phones (64A,64B) may be of an equal location.

The reported motion of the mobile phone (60) and the reported motions of the plurality of other mobile phones (64A,64B) may further be of an equal time.

The comparison of the motion of the mobile phone (60) to the average of the motions of the plurality of other mobile phones (64A,64B) may be comparison of speed.

The comparison of the motion of the mobile phone (60) to the average of the motions of the plurality of other mobile phones (64A,64B) may be an analysis of overtaking acted by a vehicle carrying the mobile phone (60).

The driving monitoring method may further include the step of, prior to the step of reporting by the mobile phone (60) motion thereof, requesting the reporting by the subscriber (55).

The reporting the motion of the mobile phone (60) by the mobile phone (60) may include reporting measurements of sensors (12,18) attached to a vehicle carrying the mobile phone (60).

In the figures and description herein, the following reference numbers (Reference Signs List) have been mentioned:
55: subscriber of the monitoring service;
number 60 denotes a phone of the person being monitored;
62: report of event reported to subscriber 55;
64A,64B: phone of drivers of the public;
66: undertaking;
68: dashboard camera

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A driving recording method, comprising the steps of:
reporting along time to a mobile phone navigation application by a mobile phone, motion of said mobile phone;
reporting along time to said mobile phone navigation application by a plurality of other mobile phones, motions of said other mobile phones;
comparing said motion of said mobile phone to an average of said motions of said plurality of other mobile phones; and
recording and reporting said comparison to a subscriber.

2. The driving recording method according to claim 1, wherein said reported motion of said mobile phone and said reported motions of said plurality of other mobile phones are of an equal location.

3. The driving recording method according to claim 2, wherein said reported motion of said mobile phone and said reported motions of said plurality of other mobile phones are further of an equal time.

4. The driving recording method according to claim 1, wherein said comparison of said motion of said mobile phone to said average of said motions of said plurality of other mobile phones comprises comparison of speed.

5. The driving recording method according to claim 1, wherein said comparison of said motion of said mobile phone to said average of said motions of said plurality of other mobile phones comprises analysis of overtaking acted by a vehicle carrying said mobile phone.

6. The driving recording method according to claim 1, further comprising the step of, prior to said step of reporting by said mobile phone motion thereof, requesting said reporting by said subscriber.

7. The driving recording method according to claim 1, wherein said reporting said motion of said mobile phone by said mobile phone, comprises reporting measurements of sensors attached to a vehicle carrying said mobile phone.
